(19) United States
(12) Patent Application Publication
(10) Pub. No.: US 2021/0144969 A1
(43) Pub. Date: May 20, 2021

(54) SYSTEM, METHOD, AND APPARATUS FOR POSITIONING AN ANIMAL

(71) Applicant: Kenneth Stoll, Houston, TX (US)

(72) Inventor: Kenneth Stoll, Houston, TX (US)

(21) Appl. No.: 17/065,119

(22) Filed: Oct. 7, 2020

Related U.S. Application Data
(60) Provisional application No. 62/937,935, filed on Nov. 20, 2019.

(51) Int. Cl. A01K 15/04; F16M 11/04; F16M 11/06; G03B 15/00

(52) U.S. Cl. CPC A01K 15/04; F16M 11/043; F16M 2200/06; G03B 15/00; F16M 11/06

(57) ABSTRACT

Systems, methods, and apparatuses are disclosed for positioning an animal. One apparatus includes an animal stand. The animal stand includes: a base having multiple legs; a vertical extension coupled to the legs; and an adjustable arm coupled to the vertical extension. The legs are configured to support the vertical extension. The adjustable arm has a first diameter. The adjustable arm has a first end and a second end. The first end is slidable coupled to the vertical extension. The second end includes a holder. The holder is sized to hold an object with a second diameter greater than the first diameter.

### CROSS-REFERENCE TO RELATED APPLICATIONS

This application claims priority to U.S. Patent Application Ser. No. 62/937,935 entitled “TOOL FOR POSITIONING WILD ANIMALS FOR THE PURPOSE OF TAKING A PHOTOGRAPH” and filed on Nov. 20, 2019 for Kenneth Stoll, which is incorporated herein by reference in its entirety.

### FIELD

This disclosure relates generally to stands, and more particularly to systems, methods, and apparatuses for positioning an animal.

### BACKGROUND

In certain circumstances, an individual may seek to position an animal, such as for taking a picture of the animal. It may be difficult for the individual to position an animal by holding the animal and to take a good picture of the animal.

### SUMMARY

The subject matter of the present application provides examples of animal positioning devices, systems, and methods that overcome the above-discussed shortcomings of prior art techniques. The subject matter of the present application has been developed in response to the present state of the art, and in particular, in response to shortcomings of current animal positioning devices and/or methods.

In one embodiment, an animal stand includes: a base having multiple legs; a vertical extension coupled to the legs; and an adjustable arm coupled to the vertical extension. The legs are configured to support the vertical extension. The adjustable arm has a first diameter. The adjustable arm has a first end and a second end. The first end is slidable coupled to the vertical extension. The second end includes a holder. The holder is sized to hold an object with a second diameter greater than the first diameter.

In another embodiment, an animal stand includes: a base; a vertical extension coupled to the base; and an adjustable arm coupled to the vertical extension. The base is configured to support the vertical extension to provide stability. The adjustable arm is slidable coupled to the vertical extension. The adjustable arm includes a holder. The holder is configured to partially surround a neck of an animal.

The described features, structures, advantages, and/or characteristics of the subject matter of the present disclosure may be combined in any suitable manner in one or more examples, including embodiments and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example, embodiment, or implementation. In other instances, additional features and advantages may be recognized in certain examples, embodiments, and/or implementations that may not be present in all examples, embodiments, or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings depict only typical examples of the subject matter, they are not therefore to be considered to be limiting of its scope. The subject matter will be described and explained with additional specificity and detail through the use of the drawings, in which:

FIG. 1 is a schematic, perspective view of a system for positioning an animal, according to one or more examples of the present disclosure;

FIG. 2 is a schematic, perspective view of the system of FIG. 1, according to one or more examples of the present disclosure;

FIG. 3 is a schematic, perspective view of the system of FIG. 1, according to one or more examples of the present disclosure;

FIG. 4 is a schematic, perspective view of the system of FIG. 1, according to one or more examples of the present disclosure;

FIG. 5 is a schematic, perspective view of another system for positioning an animal, according to one or more examples of the present disclosure; and

FIG. 6 is a schematic, perspective view of yet another system for positioning an animal, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Disclosed herein is probe for non-destructively inspecting a hat stiffener. The probe includes movable feet that engage the hat stiffener to help contain fluid within a fluid chamber of the probe as the probe inspects the hat stiffener. The feet are configured to movably conform to hat stiffeners of varying shapes and sizes. Accordingly, the same probe can be used to inspect multiple differently-configured hat stiffeners, which saves time and costs over prior art techniques requiring the swapping out of multiple differently-configured probes in order to inspect multiple hat stiffeners of different configurations. Additionally, the feet of the probe of the present disclosure cooperate with each other to facilitate self-centering of the probe on the hat stiffener.

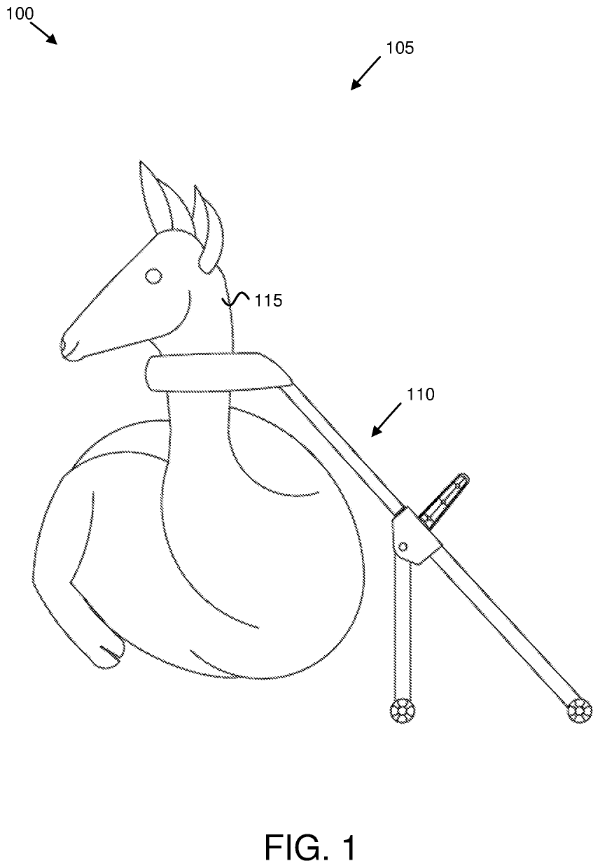

FIG. 1 is a schematic, perspective view 100 of a system 105 for positioning an animal, according to one or more examples of the present disclosure. The system 105 includes a stand 110 used for positioning an animal 115. The stand 110 (or tool) may be used for positioning animals such as wild animals. For example, the stand 110 may be used for positioning deer, antlered animals, and/or non-antlered animals. The stand 110 enables the animal 115 to be positioned in a manner that takes weight off of the head and neck of the animal 115 to further enable the animal 115 to be postured in a free-standing pose for taking pictures of the animal 115 without any support separate from the stand 110.

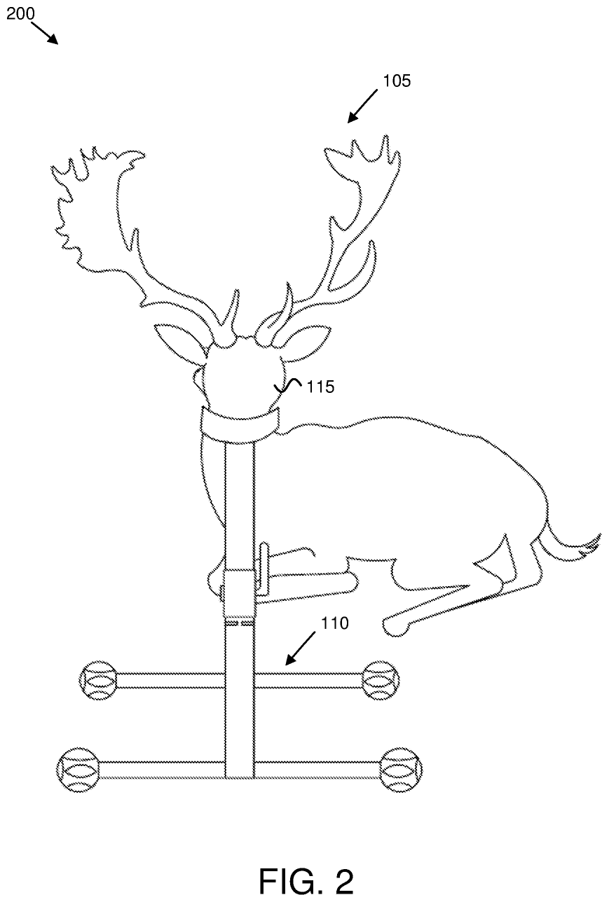

FIG. 2 is a schematic, perspective view 200 of the system 105 of FIG. 1, according to one or more examples of the present disclosure showing the system 105 from a different perspective.

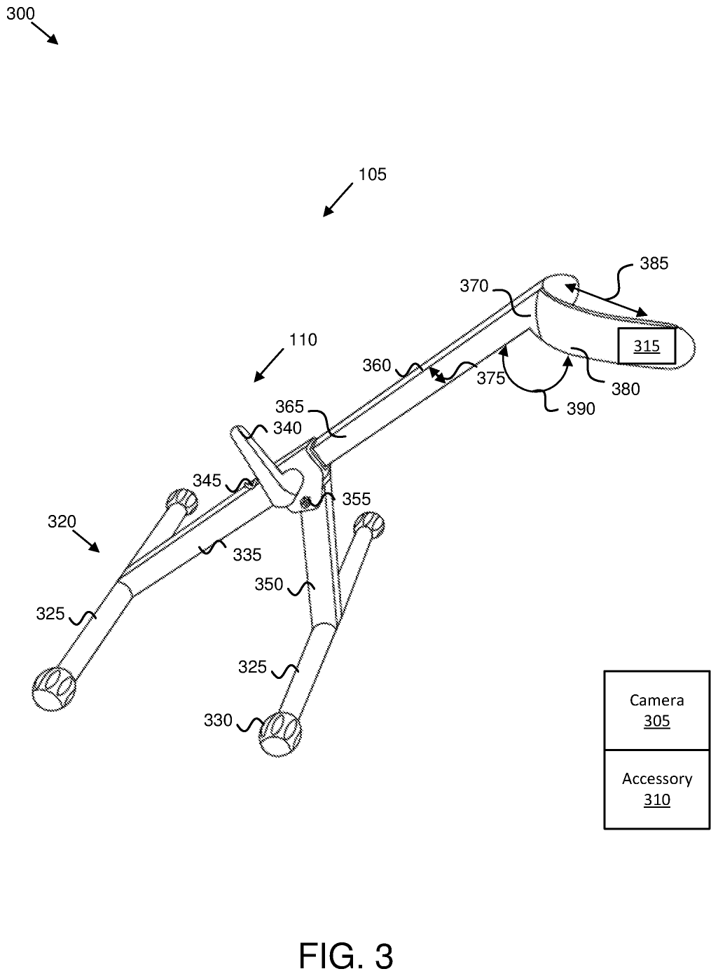

FIG. 3 is a schematic, perspective view 300 of the system 105 of FIG. 1, according to one or more examples of the present disclosure. As illustrated, the system 105 includes the stand 110. Furthermore, the system 105 may include one or more of the following electronic devices: a camera 305, an accessory 310, and/or an electronic control device 315. In certain embodiments, one or more of the electronic devices may be used to communicate with a mobile device to facilitate taking pictures of the animal 115 positioned in the stand 110 (e.g., animal stand) in a hands-free mode. In some embodiments, the camera 305 is part of a mobile device, such as a mobile phone, a tablet, a laptop, and/or a computer. In various embodiments, the accessory 310 and/or the electronic control device 315 may physically and/or wirelessly communicate with the camera 305 to signal to the camera 305 to take a picture. The camera 305 or a device containing the camera 305 may include software for physically and/or wirelessly communicating with the accessory 310 and/or the electronic control device 315. In certain embodiments, a person taking a picture may provide a physical input (e.g., press a button) and/or provide an audio input (e.g., provide a voice command) to the camera 305, the accessory 310, and/or the electronic control device 315 to take a picture. Accordingly, the person taking the picture may be in the picture with the animal 115 positioned in the stand 110 and control the camera 305 to take the picture. In some embodiments, the electronic control device 315 may be built-in to the stand 110. Although illustrated as being in one location, the electronic control device 315 may be physically positioned at any location on the stand 110.

The stand 110 includes a base structure 320 having one or more legs 325 configured provide stability. The legs 325 are configured to support the stand 110 and an animal positioned in the stand 110. As illustrated, the base structure 320 includes two sets of legs 325 positioned parallel to one another. Each of the legs 325 includes an end cap 330 (e.g., rubber attachments, grip) to provide friction to a surface that the stand 110 is positioned on. The end cap 330 may be a rubber attachment that may include rubber materials such as thermoplastics, latex, silicone, and so forth. The legs 325 may be any suitable size and/or shape suitable for supporting the stand 110 and an animal. Moreover, the legs 325 may be formed from any suitable material, such as metal, plastic, fiberglass, wood, and so forth. As used herein, metal may include steel, aluminum, or any other metal or metal alloy.

A vertical extension rod 335 is coupled to a first set of legs 325 in approximately a center of the first set of legs 325 and at approximately a 90-degree angle relative to the first set of legs 325. The first set of legs 325 is configured to support the vertical extension rod 335. A securing mechanism 340 is coupled to an end of the vertical extension rod 335 for adjusting a height of the stand 110. A clip 345 is attached to the vertical extension rod 335. The clip 345 may be used to hold the stand 110 together when collapsed and not in use.

A pivot rod 350 is coupled to a second set of legs 325 in approximately a center of the second set of legs 325 and at approximately a 90-degree angle relative to the second set of legs 325. A fastener 355 may be used to hold the pivot rod 350 in place.

An adjustable arm 360 is coupled to the vertical extension rod 335. The adjustable arm 360 has a first end 365 and a second end 370. The first end 365 of the adjustable arm 360 is inserted into an opening in the vertical extension rod 335. A height of the stand 110 may be adjusted by changing an amount of the adjustable arm 360 that extends out of the vertical extension rod 335 and the position of the adjustable arm 360 may be held in place using the securing mechanism 340. The securing mechanism 340 is configured to hold the adjustable arm 360 and the vertical extension rod 335 together. The adjustable arm 360 has a first diameter 375 that is sized to fit within the vertical extension rod 335. In some embodiments, the first diameter 375 of the adjustable arm 360 may facilitate the vertical extension rode 335 fitting within the adjustable arm 360. The adjustable arm 360 is slidably coupled to the vertical extension rod 335.

The vertical extension rod 335, the pivot rod 350, and the adjustable arm 360 may be any suitable size and/or shape. Moreover, the vertical extension rod 335, the pivot rod 350, and the adjustable arm 360 may be formed from any suitable material, such as metal, plastic, fiberglass, wood, and so forth.

A holder 380 is coupled to the second end 370 of the adjustable arm 360. The holder 380 is sized to hold an object (e.g., neck of an animal) having a second diameter 385. As may be appreciated, the second diameter 385 may be at least 2 to 20 times as large as the first diameter 375. For example, the second diameter 385 may be 2, 3, 4, 5, 6, 8, 10, 12, 15, 18, or 20 times as large as the first diameter 375. The holder 380 may be any suitable size and may have an adjustable size to adjust to the size of animal it is used to hold. The holder 380 may be any suitable shape, such as “C” shaped, “U” shaped,” “V” shaped, flat shaped, and so forth. The holder 380 may be configured to at least partially surround a neck of an animal. In some embodiments, the holder 380 may include two pieces, a first piece attached to the second end 370 of the adjustable arm 360, and a second piece that attaches to the first piece to hold the animal in place. The holder 380 may be formed from any suitable material, such as metal, plastic, fiberglass, wood, and so forth. Moreover, the holder 380 may include a pad to protect the neck of the animal from being damaged. An angle 390 between the holder 380 and the adjustable arm 360 may be fixed or may be variable. For example, in certain embodiments, the angle 390 between the holder 380 and the adjustable arm 360 may be variable to properly position an animal in the holder 380. The angle 390 may be any suitable angle, such as being at or greater than 10 degrees, 20 degrees, 45 degrees, 50 degrees, 85 degrees, 90 degrees, 135 degrees, and so forth. For example, the angle 390 may be anywhere in the range of 1 degree to 180 degrees relative to the adjustable arm 360.

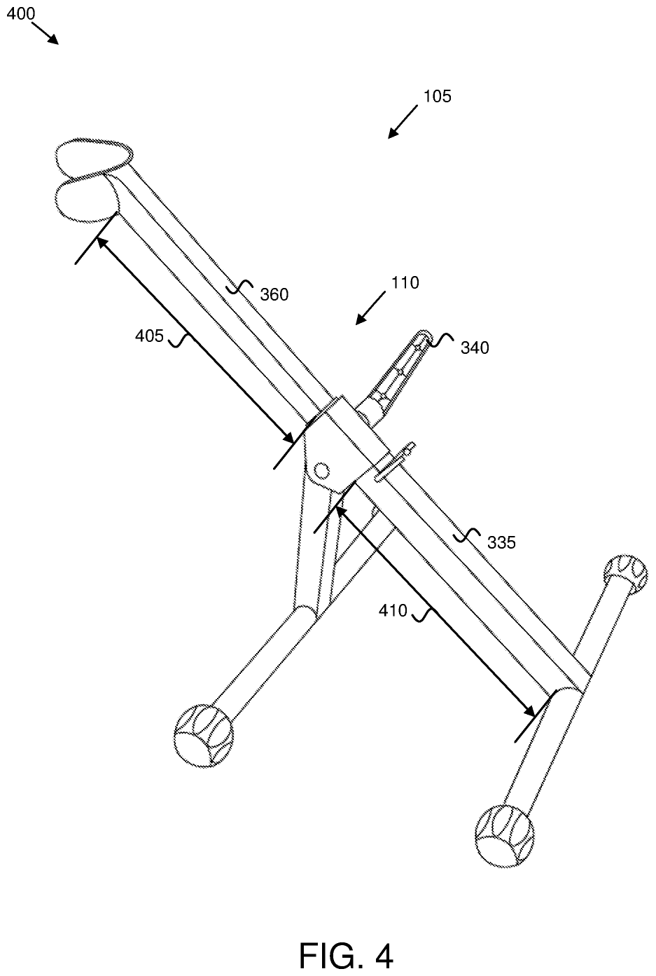

FIG. 4 is a schematic, perspective view 400 of the system 105 of FIG. 1, according to one or more examples of the present disclosure. As may be appreciated, the securing mechanism 340 of the stand 110 is configured to hold the adjustable arm 360 at a selected length that includes a first length 405 of the adjustable arm 360 and a second length 410 of the vertical extension rod 335. The first length 405 may be any suitable length, such as 0 to 25 inches. For example, the first length 405 may be 1 inch, 10 inches, 15 inches, or 20 inches. The second length 410 may be any suitable length, such as 1 to 25 inches. For example, the first length 405 may be 1 inch, 10 inches, 15 inches, or 20 inches. Thus, the selected length may be somewhere in the range of 1 to 50 inches, in some embodiments. In some embodiments, the selected length includes a length of the securing mechanism 340.

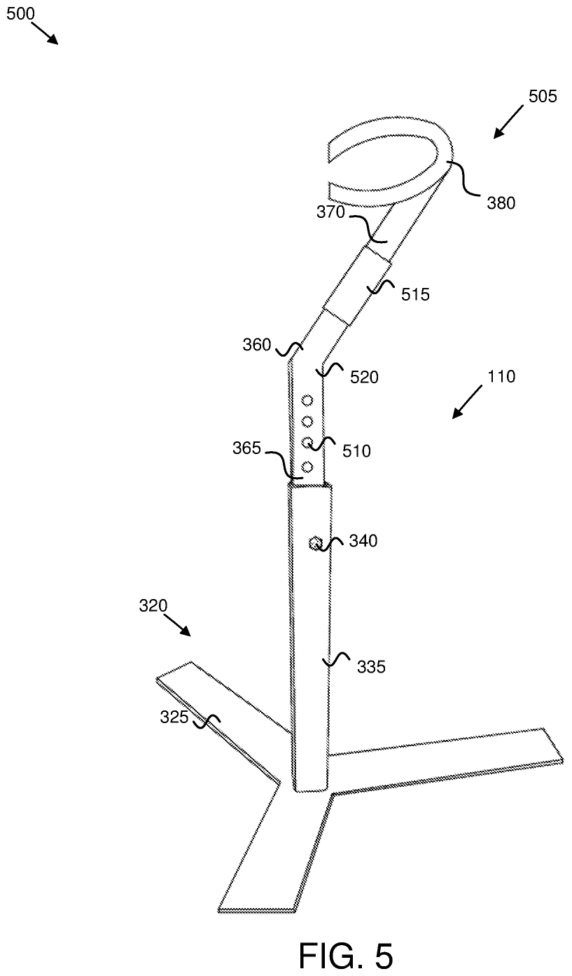

FIG. 5 is a schematic, perspective view 500 of another system 505 for positioning an animal, according to one or more examples of the present disclosure. The system 505 includes the stand 110 having three legs 325 extending at approximately a 90-degree angle from the vertical extension rod 335 (e.g., perpendicular to the vertical extension rod 335). The three legs 325 have an angle of approximately 120-degrees between each other. As may be appreciated, other embodiments may include 3, 4, 5, 6, or more legs. In this embodiment of the stand 110, adjustment holes 510 are disposed in the adjustable arm 360 to enable fixed position adjustment of the adjustable arm 360 relative to the vertical extension rod 335. Furthermore, the stand 110 includes a grip 515 around the adjustable arm 360 to facilitate moving the adjustable arm 360 relative to the vertical extension rod 335. The grip 515 may be formed from foam, cloth, or another material that is softer and/or easier to hold than the adjustable arm 360. Moreover, the adjustable arm 360 includes a bend 520 so that a top portion of the adjustable arm 360 extends at a different angle than a bottom portion of the adjustable arm 360. The angle of the bend may be any suitable angle, such as somewhere in the range of 90 to 180 degrees.

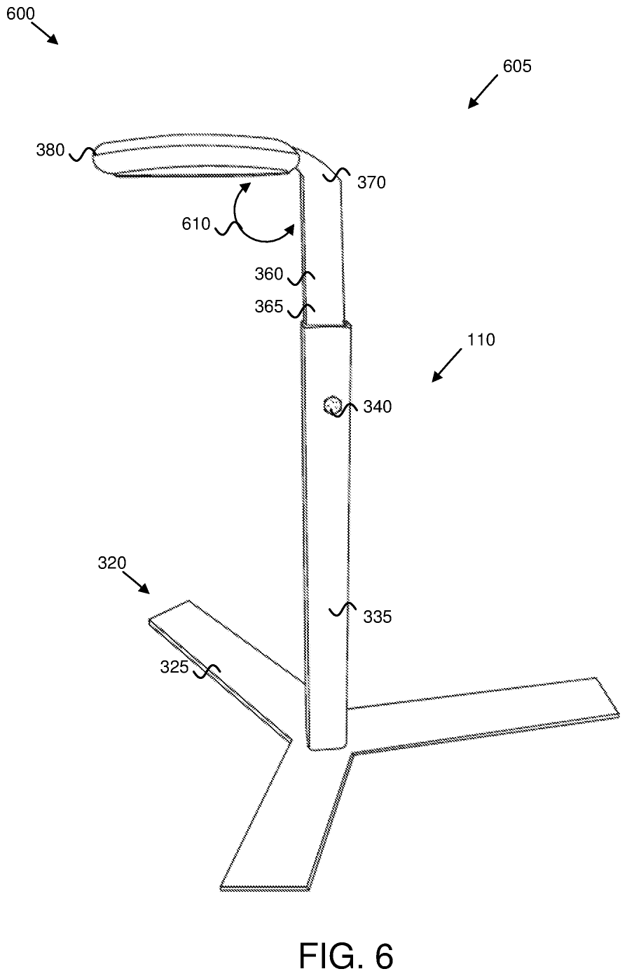

FIG. 6 is a schematic, perspective view 600 of yet another system 605 for positioning an animal, according to one or more examples of the present disclosure. The system 605 includes the stand 110 having three legs 325 extending at approximately a 90-degree angle from the vertical extension rod 335 (e.g., perpendicular to the vertical extension rod 335). The three legs 325 have an angle of approximately 120-degrees between each other. An angle 610 between the holder 380 and the adjustable arm 360 is approximately 90-degrees.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An animal stand comprising:
a base comprising a plurality of legs;
a vertical extension coupled to the plurality of legs, wherein the plurality of legs are configured to support the vertical extension; and
an adjustable arm coupled to the vertical extension, wherein:
the adjustable arm has a first diameter;
the adjustable arm comprises a first end and a second end;
the first end is slidable coupled to the vertical extension;
the second end comprises a holder; and
the holder is sized to hold an object with a second diameter greater than the first diameter.

2. The animal stand of claim 1, wherein the plurality of legs comprises three legs extending substantially perpendicular to the vertical extension.

3. The animal stand of claim 1, wherein the plurality of legs comprises two legs extending substantially perpendicular to the vertical extension.

4. The animal stand of claim 1, further comprising a securing mechanism configured to hold the adjustable arm and the vertical extension together.

5. The animal stand of claim 4, wherein the securing mechanism holds the adjustable arm and the vertical extension together at a selected length comprising a first length of the adjustable arm and a second length of the vertical extension.

6. The animal stand of claim 1, wherein the holder comprises a “c” or “u” shape configured to partially enclose a neck of an animal.

7. The animal stand of claim 1, wherein an angle of the holder relative to the adjustable arm is variable.

8. The animal stand of claim 1, wherein an angle of the holder relative to the adjustable arm is at least 45 degrees.

9. The animal stand of claim 1, wherein an angle of the holder relative to the adjustable arm is at least 85 degrees.

10. The animal stand of claim 1, further comprising an electronic device configured to communicate with a mobile device to facilitate taking a picture of an animal positioned in the animal stand in a hands-free mode.

11. An animal stand comprising:
a base;
a vertical extension coupled to the base, wherein the base is configured to support the vertical extension to provide stability; and
an adjustable arm coupled to the vertical extension, wherein:
the adjustable arm is slidable coupled to the vertical extension;
the adjustable arm comprises a holder; and
the holder is configured to partially surround a neck of an animal.

12. The animal stand of claim 11, wherein the base comprises three legs extending substantially perpendicular to the vertical extension.

13. The animal stand of claim 11, wherein the base comprises two legs extending substantially perpendicular to the vertical extension.

14. The animal stand of claim 11, further comprising a securing mechanism configured to hold the adjustable arm and the vertical extension together.

15. The animal stand of claim 14, wherein the securing mechanism holds the adjustable arm and the vertical extension together at a selected length comprising a first length of the adjustable arm and a second length of the vertical extension.

16. The animal stand of claim 11, wherein the holder comprises a “c” or “u” shape.

17. The animal stand of claim 11, wherein an angle of the holder relative to the adjustable arm is variable.

18. The animal stand of claim 11, wherein an angle of the holder relative to the adjustable arm is at least 45 degrees.

19. The animal stand of claim 11, wherein an angle of the holder relative to the adjustable arm is at least 85 degrees.

20. The animal stand of claim 11, further comprising an electronic device configured to communicate with a mobile device to facilitate taking a picture of an animal positioned in the animal stand in a hands-free mode.
